(19) United States
(12) Patent Application Publication
(10) Pub. No.: US 2026/0192653 A1
(43) Pub. Date: Jul. 9, 2026

(54) COOLING BOX FOR SNOWMOBILES

(71) Applicant: Kyle E. Heaps, Lehi, UT (US)

(72) Inventor: Kyle E. Heaps, Lehi, UT (US)

(21) Appl. No.: 19/438,365

(22) Filed: Dec. 31, 2025

Related U.S. Application Data
(60) Provisional application No. 63/741,802, filed on Jan. 3, 2025.

(51) Int. Cl. B60K 11/00; B62M 27/02

(52) U.S. Cl. CPC B60K 11/00; B62M 27/02

(57) ABSTRACT

A cooler box for a snowmobile may increase operational time by approximately 50%. The cooler box may feature an open-sided box body fashioned of metal, composite or any other suitable material. The box defines an interior volume intended to be packed with any available snow or ice a rider may find. When suitably packed, the box may then be mounted, open side down, directly on the cargo bed of a liquid-cooled snowmobile, over the heat exchange assembly. This thermal mass is then used to cool the cooling fluids and extend engine life. Melted liquids may then drain from underneath the box. The box may be attached using bosses compatible with the most common stowage systems today, or any future or previously developed. Ideally, the cooler box may allow for additional cargo stowage on top of the box.

### CROSS-REFERENCES TO RELATED APPLICATIONS

The present invention claims the benefit of priority to prior filed U.S. Provisional Application No. 63/741,802, filed on Friday, Jan. 3, 2025, and incorporates the same by reference herein in its entirety.

### FIELD OF THE INVENTION

The present invention relates to the field of outdoor recreational vehicles and more particularly relates to a cooling box for use with snowmobiles.

### BACKGROUND OF THE INVENTION

The first snowmobiles were developed in the early 20^{th} Century in an effort to create useful vehicles which would be able to effectively provide transportation over snow-covered terrain. Typically, these early machines would consist of an engine driving an endless track for locomotion while a pair of front skis or runners would provide steering capability. Over these past century, these work machines have become lighter and more powerful and are commonly used for both work and play in climates where snow is plentiful. As the snowmobile is built for use in snow, the intended use has been integrated into many features of the modern snowmobile design. One common feature is the cooling system for the engine. As with an automobile, a combustion engine generates heat which must be dissipated for effective, long-term use. The modern automobile combustion engine uses a fan-cooled radiator as a heat exchanger. Coolant fluids are run through the engine block and into the radiator. The fan is run over the radiator to cool the interior fluids before they return back into the engine. Similarly, fluids in a liquid-cooled combustion engine of a snowmobile are drawn outside the engine. However, at least a portion of these fluids are typically directed into a tubing system that extends underneath the snowmobile's rear cargo bed, over the drive track (in the “tunnel”). When running, this track kicks snow onto this tubing system and cools the fluids with, essentially, ice rather than just air.

The cooling system of a modern snowmobile is well developed for situations where there is plenty of snow. However, as the season wanes snow levels may be inadequate to provide effective cooling of the engine. For this reason, ice scratchers are positioned in front of the runners to kick up any snow that might be available. Studded tracks may also kick up additional residual snow and ice, but these are often installed for reasons other than engine cooling (e.g., consistent use on ice or hard-packed snow). However, there is a limit as to how effective these strategies can be. This can be somewhat disappointing for riders as the snowmobile is otherwise perfectly adaptable to other terrain. Being able to traverse terrain without snow adds to the efficacy of the vehicle and allows the rider to travel between patches of snow while stopping fewer times to wait for the engine to cool.

One solution is to put a heat sink over the heat exchanger, on the cargo rack. A previous attempt at this strategy utilized a flaccid sack which could be filled with ice and snow and secured behind the seat of the snowmobile with straps. However, this sack tends to be less secure as its contents melt. Th use of the sack also precludes additional cargo. Another solution is a more permanent box mounted upon the heat exchanger. Slots and rails are placed on the lid of this structure for cargo stowage. However, the unit provides more encumbrance to the snowmobile and is not perfectly compatible with modern stowage systems.

What is needed is a way to reliably maintain a cold heat sink proximate the cooling system of a snowmobile in order to extend the operational time of the vehicle in a manner that will still allow the rear cargo platform to be used. The present invention is a cooler box designed to sit over the heat exchanger found in the rear platform of a snowmobile. When packed with snow, the box provides a heat sink which will extend the use of the vehicle by approximately 50%—a significant lengthening over current cooling strategies. It also provides multiple attachment points for ach mounting of hardware to facilitate current and future stowage strategies.

### SUMMARY OF THE INVENTION

In view of the foregoing disadvantages inherent in the known types of snowmobile engine cooling systems, an improved cooling strategy may provide a cooling box that meets the following objectives: that it be simple and intuitive to use; that it be readily deployed when needed and stowed when not; that it integrate with current and future developed cargo stowage systems for snowmobiles; that it be easy and economical to manufacture; that it allow proper drainage of water as snow and ice melt during use; and most importantly, that when properly deployed it effectively and significantly increases the operational time of a snowmobile. In order to accomplish these objectives, a new and improved cooling box may comprise an open sided box with attachment bosses and other interfaces to mount upon the cargo bed surface of a snowmobile, over the heat exchanger.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also, it is to be understood that the phraseology and terminology employed herein are for description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

In order to describe the manner in which the above-recited and other advantages and features of the invention can be obtained, a more particular description of the invention briefly described above will be rendered by reference to specific example embodiments thereof which are illustrated in the appended drawings. Understanding that these drawings depict only typical embodiments of the invention and are therefore not to be considered as limiting of its scope, the invention will be described and explained with additional specificity and detail using the accompanying drawings.

FIG. 1 is a perspective view of an embodiment of the cooler box mounted upon a cargo platform of a snowmobile.

FIG. 2 is an alternate perspective view of the snowmobile of FIG. 1.

FIG. 3 is a top plan view of the snowmobile of FIG. 1, with attachment modules removed.

FIG. 4 is a sectional view of the snowmobile of FIG. 3, taken along line IV-IV.

FIG. 5 is a perspective view of the cooler box utilized in FIG. 1, without its modular adaptability components.

FIG. 6 is a top plan view of the cooler box of FIG. 5.

FIG. 7 is a side elevation of the cooler box of FIG. 5.

FIG. 8 is a front elevation of the cooler box of FIG. 5.

### DESCRIPTION

With reference now to the drawings, a preferred embodiment of the cooler box is herein described. It should be noted that the articles “a,” “an,” and “the,” as used in this specification, include plural referents unless the content clearly dictates otherwise.

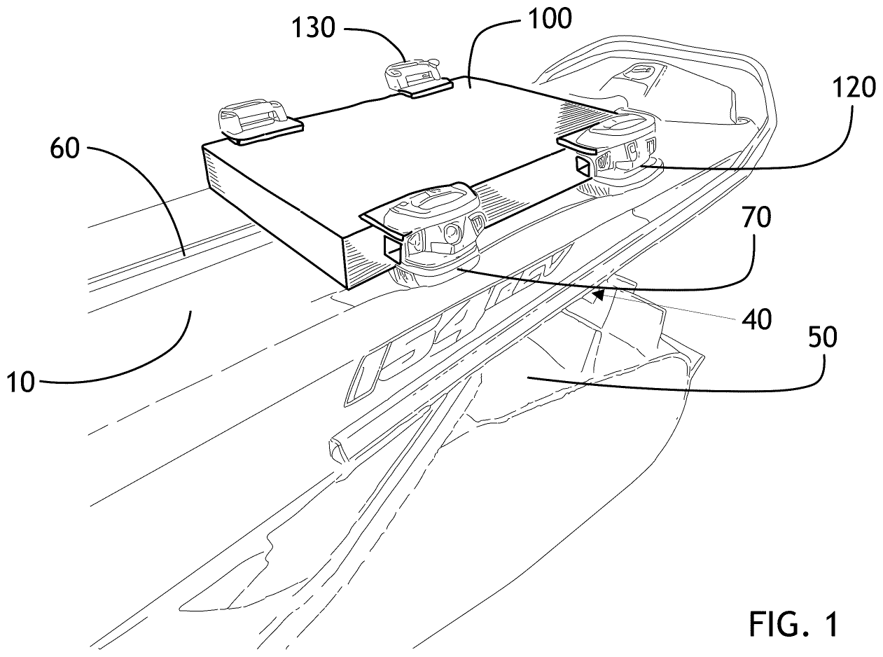

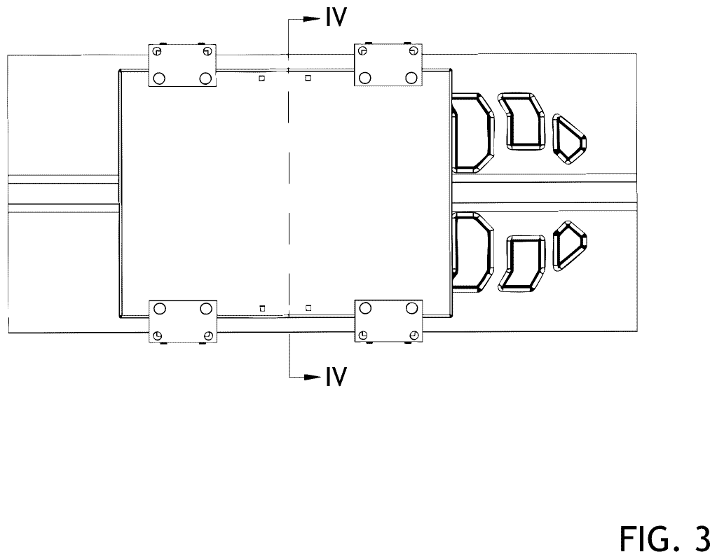

With reference to FIGS. 1-4, a cooler box 100 is designed to fit onto the rear cargo deck 10 of a snowmobile. This rear cargo deck 10 contains a heat exchange system 20 with circulating liquid coolant 30. The liquid coolant 30 circulates from the engine, underneath this platform 10 and over what is termed the “tunnel” 40, the part of the rear cargo deck 10 over the track 50. Of note, there is commonly a cable channel ridge 60 which runs the length of the cargo deck. When running over snow, the track 50 kicks snow into the tunnel 40. Coolant 30 circulates in at least one tube from the engine into the heat exchange system and over the tunnel 40, proximate the kicked-up snow, and cools before it is circulated back into the engine through at least one return tube. This process is actually a very efficient means to cool the engine of a snowmobile as it uses the natural environment to its advantage. However, when there is no snow to kick into the tunnel 40, the snowmobile overheats easily.

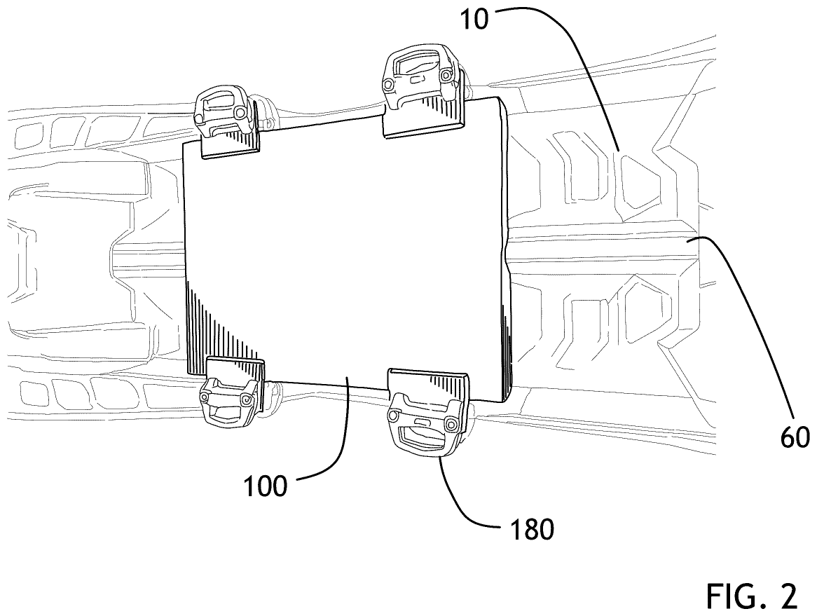

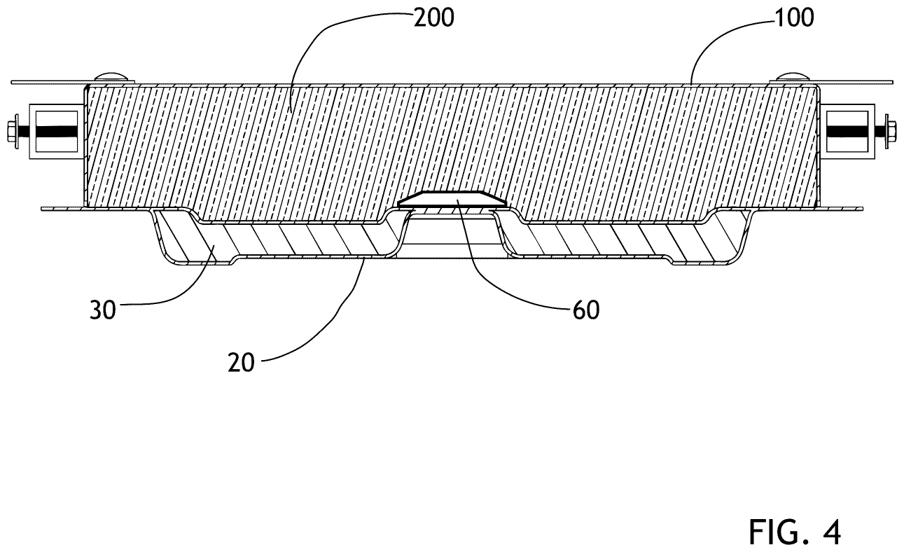

The cooler box 100 may feature hardware 170 that fit onto corresponding cargo stowage bosses 70 on the snowmobile. The cooler box 100 may also present additional stowage hardware 180 to allow for cargo to be stored thereupon. It should also be noted that while the depicted embodiment in FIGS. 1 and 2 is configured for one type of stowage system, the cooler box 100 is adaptable to many different systems. In use, the cooler box is packed with snow 200 (FIG. 4) and positioned over the heat exchanger 20. This mass of snow 200 then provides a thermal mass for cooling the engine as the heat is exchanged with the snow 200 in the cooler box 100 instead of snow in the tunnel 40.

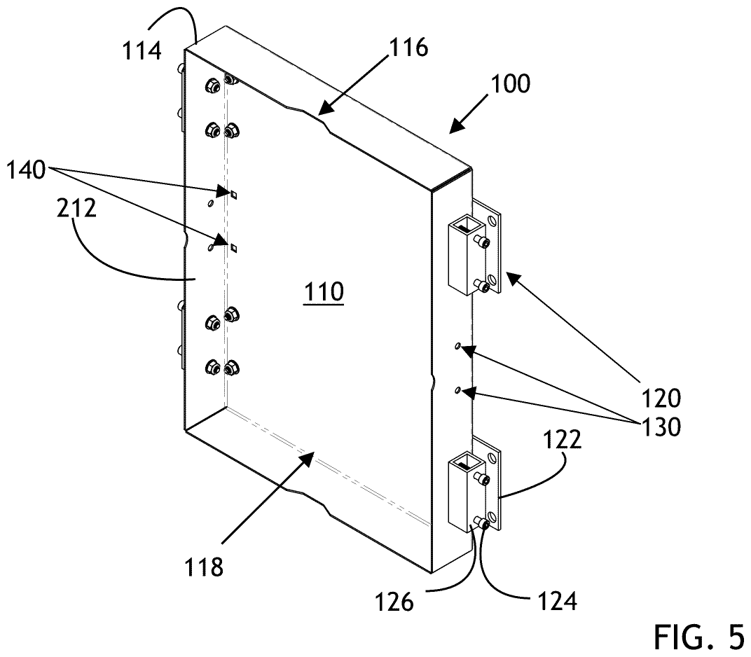

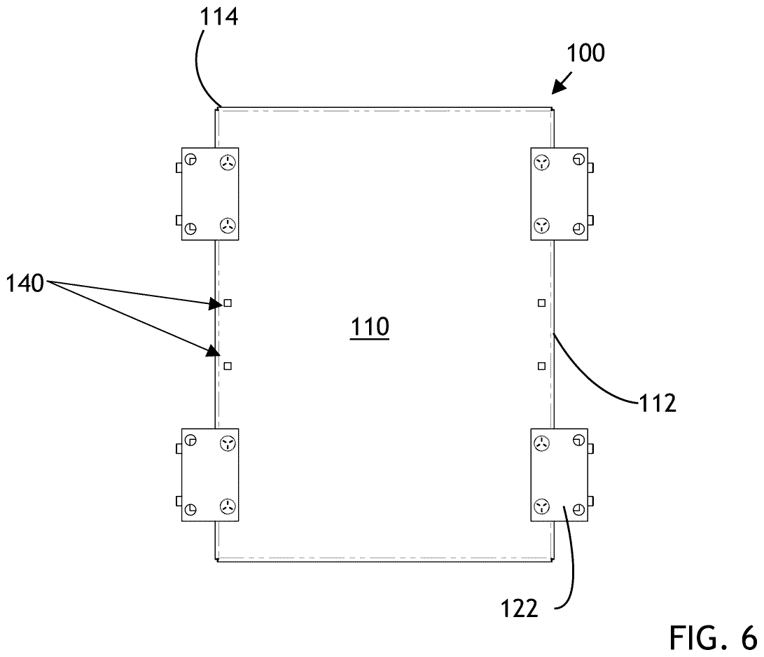

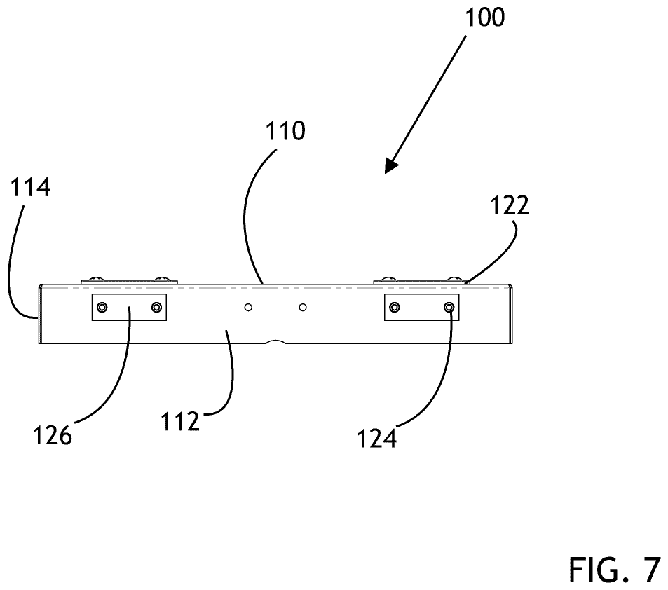

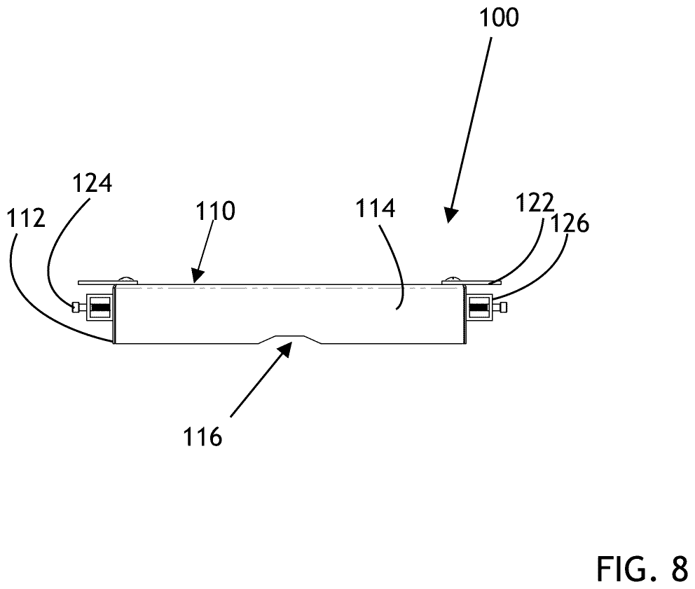

It is more readily seen that the cooler box 100 is an open sides rectangular construction with a top surface 110 and two pairs of opposed parallel sides 112, 114, as illustrated in FIGS. 5-8. Together, these five walls define an interior volume 118. Shorter sides 114 feature a notch 116 to accommodate the ridge 60, shown in FIGS. 1-4, and to provide drainage. Connection structures 120 are also provided in opposed pairs on the longer sides 112 to allow for connection to variable connection hardware 170. The structures 120 each feature a connection plate 122 mounted on the top surface 110 and extending over at least one bolt 124 with an associated housing 126. Side connection holes 130, 140 are also provided. The provision and placement of these structures and holes allow for attachment to the majority of currently used stowage connection structures, such as bosses 170. Of note, these structures are adaptable to whatever cargo stowage strategy is employed for an individual snowmobile model and may even be interchangeable to provide adaptation capability to the invention. The cooler box may be also easily adapted to later developed stowage strategies and structures by adapting the structures and hole locations to fit later developed strategies.

In use, a rider will find a quantity of snow and ice within easy access to the rider. The cooler box 100 may then be packed with this snow and ice as a cooling medium, creating a dense block of heat sink material 200. When running the vehicle, which may or may not contribute some snow kickback into the tunnel 40, the heat will be exchanged with this heat sink 200 and cause it to melt. Drainage may occur around the lower rim of the cooler box 100 and through the passage slots 116 provided therein. At some point, this heat sink 200 will be totally expended, and the rider may then simply (and ideally before developing a heat issue with the engine) find another cache of snow and repack the box. Depending on conditions, use of the cooler box may increase runtime over not having the box and relying on the ice scratchers alone by 50%. A second or more cooler boxes may also be added to the first. This may provide some additional thermal mass, but the additional mass will have a diminishing return as the additional thermal mass is located further and further from the heat exchanger. This strategy may, however, be used to carry additional snow further along the user's path so that a second or third box may be exchanged with a first box in the event additional snow is not found to repack the first box.

Although the present invention has been described with reference to preferred embodiments, numerous modifications and variations can be made and still the result will come within the scope of the invention. The embodiments described are to be considered in all respects only as illustrative and not restrictive. No limitation with respect to the specific embodiments disclosed herein is intended or should be inferred. Therefore, the scope of the invention is indicated by the appended claims rather than by the foregoing description. All changes which come within the meaning and range of equivalency of the claims are to be embraced within their scope.

What is claimed is:

1. A cooler box for a snowmobile, the cooler box comprising:
an open-sided box body with two pairs of parallel side walls and a top surface;
at least one pair of opposed plates mounted upon the top surface and extending over one pair of opposed sides, across a width of the snowmobile;
at least one bolt located in at least one bolt housing, said at least one bolt housing located underneath at least one of the opposed plates; and, connection hardware compatible with the snowmobile;
wherein the cooler box is mounted upon the snowmobile utilizing the connection hardware after being packed with a cooling medium and is immediately removable when no longer in use.

2. The cooler box of claim 1, the connection hardware being mounted upon the open-sided box body with the at least one bolt and at least one bolt housing.

3. The cooler box of claim 1, further comprising additional connection hardware mounted upon the at least one pair of opposed plates, wherein the additional connection hardware enables additional storage of similarly compatible cargo.

4. The cooler box of claim 1, further comprising a pair of opposed slots located on opposed sides along a length of the snowmobile.

5. A method of cooling a snowmobile, the method comprising:
a step of filling a first box with a cooling medium;
a step of placing and fastening the box over a heat exchanger of a snowmobile;
a step of running the snowmobile until the cooling medium melts; and,
a step of removing, refilling, and replacing the box as needed.

6. The method of claim 5, further comprising a step of filling a second box with the cooling medium and positioning and fastening the second box on top of the first box.

7. The method of claim 5, further comprising a step of placing cargo on the first box.
